(19) United States
(12) Patent Application Publication
(10) Pub. No.: US 2025/0360813 A1
(43) Pub. Date: Nov. 27, 2025

(54) HYBRID HIGH POWER CHARGER WITH AC AND DC HARMONIC CANCELLATION

(71) Applicant: Caterpillar Inc., Peoria, IL (US)

(72) Inventors: Dustin Craig Selvey, Eureka, IL (US); Dachuan Yu, Dunlap, IL (US); Asim Amir Solangi, Dunlap, IL (US); Zhe Zhao, Dunlap, IL (US)

(73) Assignee: Caterpillar Inc., Peoria, IL (US)

(21) Appl. No.: 18/675,131

(22) Filed: May 27, 2024

(51) Int. Cl. B60L 53/10; B60L 53/62; H02M 1/00; H02M 1/15

(52) U.S. Cl. CPC B60L 53/11; B60L 53/62; B60L 2200/44; B60L 2210/10; B60L 2210/30; H02M 1/0077; H02M 1/15

(57) ABSTRACT

A charging system for an off-road electric vehicle includes a transformer coupling to connect the charging system to a power grid; a bulk charger including an input connected to the transformer coupling and a differential output to be connected to a charging load; an auxiliary (AUX) charger including an isolation transformer connected to the input of the first bulk charger and a differential output connected in parallel to the differential output of the first bulk charger. Operating the AUX charger improves the power factor of the bulk charger.

### TECHNICAL FIELD

This document relates to electric powered work machines and in particular to a Megawatt class charging system for charging the energy source of electric work machines.

### BACKGROUND

Powering a large moving work machine (e.g., a wheel loader, a mining truck, etc.) with an electric motor requires a large mobile electric energy source that can provide current of up to thousands of Amperes (Amps). An example of a mobile energy source is a battery system containing multiple strings of high-capacity batteries. The batteries in each string are connected in series, and the strings of batteries are connected in parallel to provide the high output power needed by the electric work machines. The mobile energy source needs to be recharged when the energy source nears depletion. It is desired to recharge the electric energy source of a work machine as quickly as possible to minimize down time of the work machine. Chinese Patent CN106356891A relates to an asynchronous power generating device. The power generating device includes an input reactor that reduces the influence of a harmonic current generated by a rectifier of the power generating device.

### SUMMARY OF THE INVENTION

Electric powered large moving work machines use large capacity battery systems that need charging. It is desired to provide charging at a remote job site using a charging system that minimizes down time of equipment due to charging. An example charging system for an electric work machine includes a transformer coupling including a three-winding transformer to connect the charging system to a power grid; a first bulk charger including an input connected to the three-winding transformer and a differential output to be connected to a charging load; a second bulk charger including an input connected to the three-winding transformer and a differential output connected in parallel to the differential output of the first bulk charger; a first auxiliary (AUX) charger including an isolation transformer connected to the input of the first bulk charger and a differential output connected in parallel to the differential output of the first bulk charger; a second AUX charger including an isolation transformer connected to the input of the second bulk charger and a differential output connected in parallel to the differential output of the second bulk charger. Operating the first and second AUX chargers improves the power factor of the first and second bulk chargers.

An example method of operating a charging system for an electric work machine includes receiving alternating current (AC) power from a work-site power grid at an input of the charging system; converting the AC power to direct current (DC) power using a first bulk charger and a second bulk charger, wherein the second bulk charger includes a differential DC output connected in parallel to a differential DC output of the first bulk charger, and wherein the differential DC outputs of the first and second bulk chargers include DC ripple when the first and second bulk chargers are operating; reducing the DC ripple at the differential DC output of the first bulk charger using a first auxiliary (AUX) charger and reducing the DC ripple at the differential DC output of the second bulk charger using a second AUX charger to produce a reduced DC ripple charge energy; and charging a battery system of the non-road electric work machine using the reduced DC ripple charge energy.

### BRIEF DESCRIPTION OF THE DRAWINGS

FIG. 1 is an elevation view depicting an example work machine in accordance with this disclosure.

FIG. 2 is a diagram of a charging system for a work machine in accordance with this disclosure.

FIG. 3 is circuit diagram of a hybrid high power charging system for a work machine in accordance with this disclosure.

FIG. 4 is a circuit diagram of an example of a bulk charger in accordance with this disclosure.

FIG. 5 is a circuit diagram of an example of a rectifier circuit of an auxiliary charger in accordance with this disclosure.

FIG. 6 is a circuit diagram of an example of a dual active bridge circuit of an auxiliary charger in accordance with this disclosure.

FIGS. 7A-7B are circuit diagrams of an example of a control scheme for a charging system in accordance with this disclosure.

FIG. 8 is a flow diagram of an example of a method of operating a portable charging system in accordance with this disclosure.

### DETAILED DESCRIPTION

Examples according to this disclosure are directed to methods and devices that improve charging of a rechargeable energy source of an electric work machine.

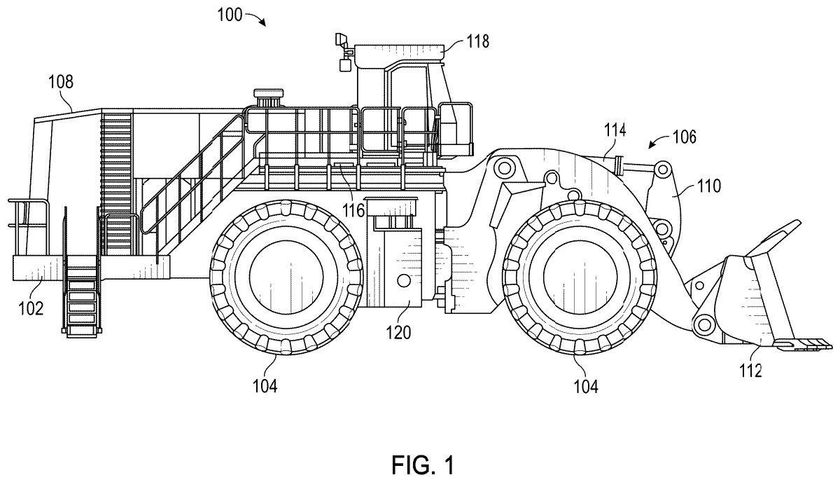

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. By further way of example, both operation by a remotely located operator and autonomous or robotic operation are contemplated. Machine 100 can be used to excavate a portion of a work site by actuating cylinders 114 to articulate bucket 112 via linkage assembly 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the work machine 100.

Charging the battery system quickly reduces the amount of time a work machine sits idle waiting for the charging to be complete. Faster charger systems typically have the capability to deliver higher power. The higher power systems may use higher power devices and power drivers, controllers, and magnetic elements. These systems may utilize advanced cooling systems to operate at the higher power. All these things can increase the cost of faster charging systems. Additionally, the design of a fast charging system needs to address alternating current (AC) grid harmonics and direct current (DC) current ripple in the charging system output. Other challenges in designing a faster charging system includes keeping the power factor at a high value (e.g., ≥0.9) for the full range of battery voltages and grid voltages. The charging systems also need to operate in job site environments that are often non ideal due to temperature, altitude, water, etc.

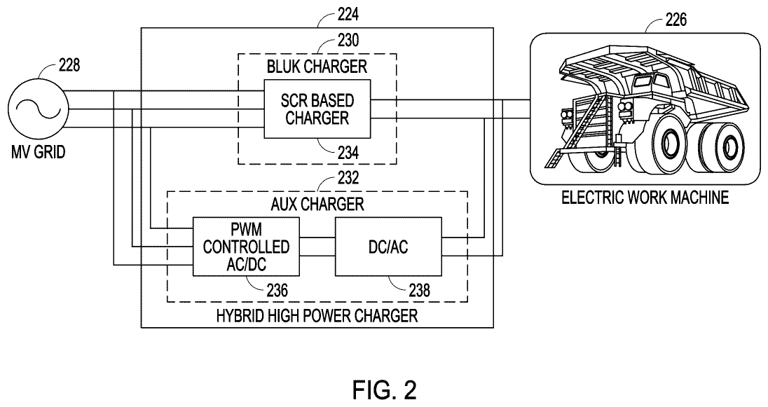

FIG. 2 is a block diagram of a system for fast charging of the energy source of an electric work machine. The system includes a hybrid high power charger 224 to charge an electric work machine 226 using a medium voltage grid (MV Grid 228). The hybrid high power charger 224 can be included in a megawatt charging station (MCS) at the jobsite. The MV Grid 228 may be derived from the electric utility grid and may provide a 35 kilovolt (35 kV), 13.8 kV, or 6.6 kV line connection for example.

The hybrid high power charger 224 includes a bulk charger subsystem 230 and an auxiliary (AUX) charger subsystem 232. The bulk charger subsystem 230 can include a higher power charging circuit but is lower in complexity and lower cost. In some examples, the bulk charger subsystem 230 includes a Silicon Controller Rectifier (SCR) based charging circuit 234. The rectifier circuit converts AC power from the MV Grid 228 to DC power to charge the energy source of the electric work machine 226. The higher power of the bulk charger subsystem 230 can provide faster charging, but the lower complexity may result in larger amplitude harmonics and ripple, and the bulk charger subsystem 230 may also have a lower power factor than desired.

The AUX charger subsystem 232 is connected in parallel to the bulk charger subsystem 230. The output power of the AUX charger subsystem 232 is much lower than the bulk charger subsystem 230. In some examples, the AUX charger subsystem 232 includes a Pulse Width Modulation (PWM) controller AC-to-DC (AC/DC) converter circuit 236 and a DC-to-DC (DC/DC) converter circuit 238. Because the output power of the AUX charger subsystem 232 is lower, the AUX charger subsystem 232 can be designed inexpensively. With appropriate control, the AUX charger subsystem 232 can be used to reduce the ripple at the output of the bulk charger subsystem 230 by cancellation and improve the power factor for the overall output of the hybrid high power charger 224.

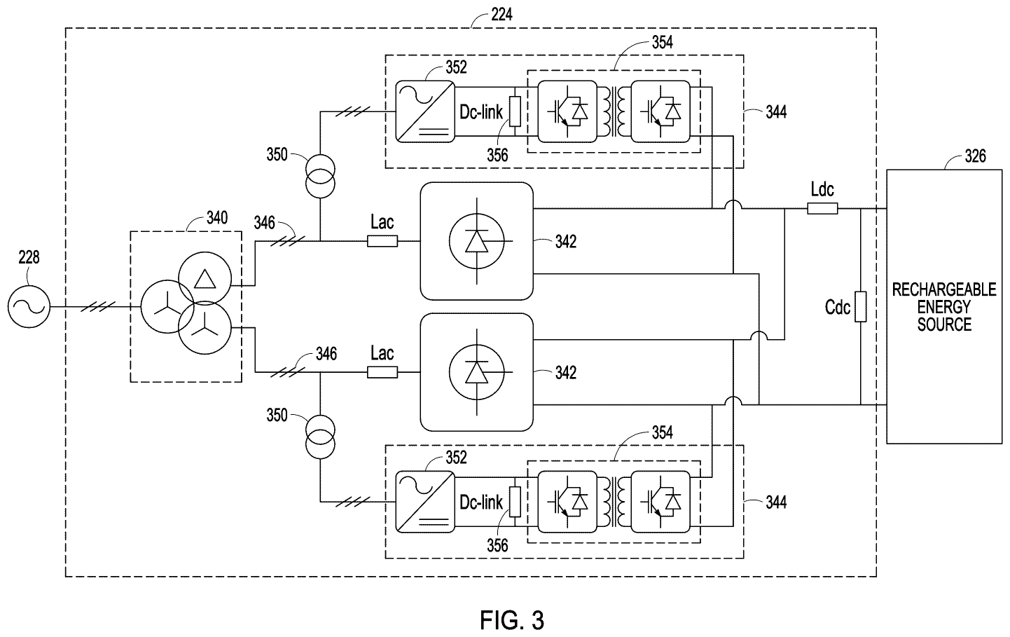

FIG. 3 is a circuit diagram of an example of the hybrid high power charger 224. The hybrid high power charger 224 includes a transformer coupling 340 to connect the hybrid high power charger 224 to a power grid (e.g., MV Grid 228). The input to the hybrid high power charger 224 is AC line power from the power grid and the output is DC power to power the rechargeable energy source 326 of the electric work machine. The transformer coupling 340 includes a three-winding transformer. In some examples, the transformer coupling 340 includes a Y-Delta-Y connected transformer. The hybrid high power charger 224 includes a bulk charging subsystem and an auxiliary charging subsystem. The bulk charging subsystem includes a first bulk charger circuit 342 and a second bulk charger circuit 342. Each bulk charger circuit 342 can include AC inductors (Lac) at the input to receive and filter a three phase AC input 346 from the transformer coupling 340. The Y-Delta-Y transformer may produce a phase shift at the inputs to the bulk chargers. The bulk charger circuits 342 have differential outputs that are connected in parallel, and the outputs of the bulk charger circuits 342 are connected in parallel to a DC inductor (Ldc) and a DC capacitor (Cdc). The bulk charger circuits 342 can be SCR-based and can include switched SCR-based AC/DC converters.

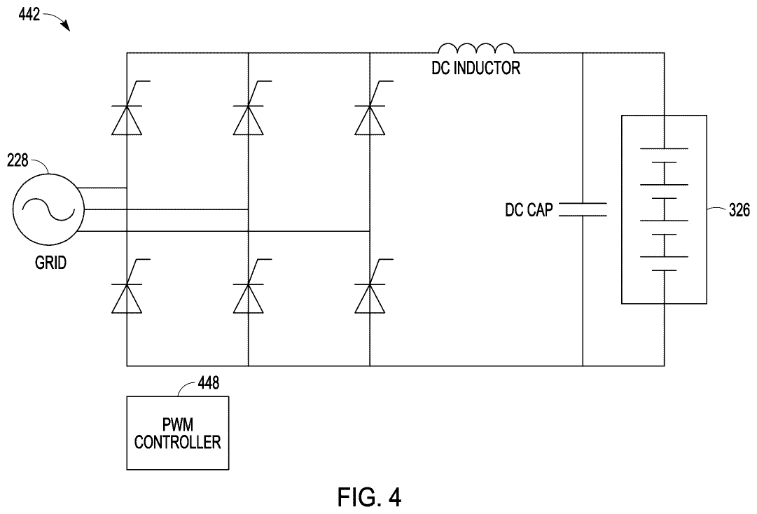

FIG. 4 is a circuit diagram of an example of a switched AC/DC converter circuit 442 usable in the bulk charging system of FIG. 3. The switched AC/DC converter circuit 442 is SCR-based. The switched AC/DC converter circuit 442 has a three-phase connection to the power grid. The transformer coupling to the power grid is not shown. The switched AC/DC converter circuit 442 has a differential DC output that is connected to the DC inductor, DC capacitor, and the rechargeable energy source 326. The DC inductor and DC capacitor are a passive DC filter circuit. A PWM controller 448 provides control signals to control switching of the SCRs. In certain examples, the PWM controller 448 is a six-signal pulse generator circuit that provides a control signal to each of the six SCRs to control conversion of the AC input to the differential DC output. In certain examples, the PWM controller 448 implements proportional-resonant (PR) control and produces control signals according to PR control.

Returning to FIG. 3, the auxiliary charging subsystem includes a first AUX charger circuit 344 and a second AUX charger circuit 344. The first AUX charger circuit 344 includes a differential output connected in parallel to the differential output of the first bulk charger circuit and the second AUX charger circuit 344 includes a differential output connected in parallel to differential output the second bulk charger circuit. The inputs of AUX charger circuits 344 are isolated from the inputs of the bulk charger circuits 342 by isolation transformers 350 connected to the inputs of the bulk charger circuits 342. The AUX charger circuits 344 include a rectifier circuit 352 to convert the AC input from the transformer coupling 340 to DC. The AUX charger circuits 344 include a DC/DC converter circuit 354 to convert the DC output of the rectifier circuits 352 to the DC level used to charge the energy source 326. A DC link capacitor 356 is arranged between the rectifier circuits 352 and the DC/DC converter circuits 354.

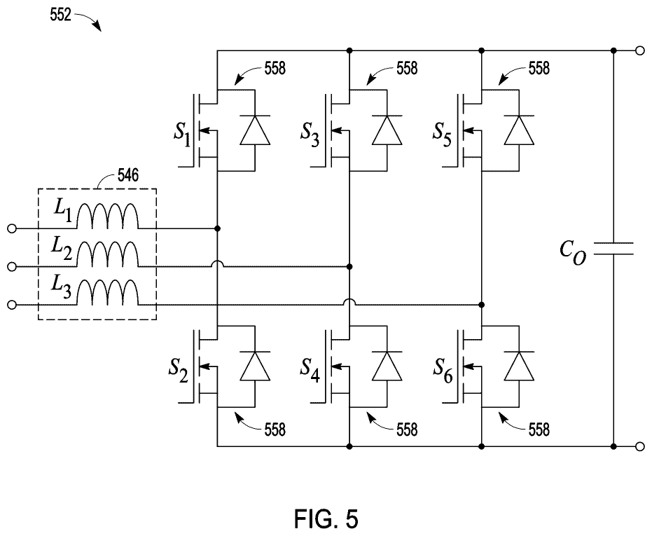

FIG. 5 is an example of a switching rectifier circuit 552 usable as the rectifier circuit 352 of FIG. 3. The rectifier circuit 552 is a PWM rectifier circuit and includes three-phase input 546 connected to the respective isolation transformer. The rectifier circuit 552 may be an active front end (AFE) rectifier circuit with AFE comprised of insulated gate transistors 558.

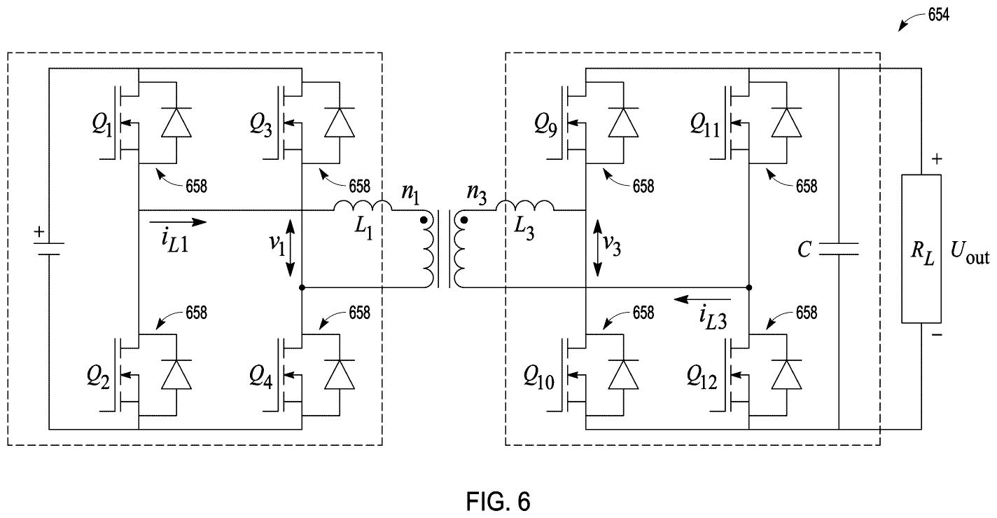

FIG. 6 is an example of a switching DC/DC converter circuit 654 usable as the DC/DC converter circuits 354 in FIG. 3. The DC/DC converter circuit 654 is a dual active bridge (DAB) DC/DC converter circuit that includes insulated gate transistors 658 as the switching elements.

Returning to FIG. 3, the bulk charger circuits 342 are designed to be high power and comparably inexpensive. The differential DC output of the bulk converter circuits 342 may exhibit DC ripple when operating. The control timing of the AUX charger circuits 344 is designed to provide a ripple output signal to cancel the DC ripple of the bulk charger circuits 342. The outputs of the AUX charger circuits are connected in parallel to the outputs of the bulk charger circuits 342. The AUX charger circuits 344 provide a ripple output signal that has a one hundred eighty degree (180°) phase shift from the DC ripple output of its corresponding bulk charger circuit 342. This phase shift control causes the AUX charger circuits 344 output ripple to cancel and reduce the output ripple of the bulk charger circuits 342.

The differential DC output of the bulk converter circuits 342 may also exhibit an AC harmonic signal component when operating. The AC harmonic signal component may include harmonic frequencies of the fundamental frequency of the MV Grid 228. The AUX charger circuits 344 provide a current output signal having the harmonic frequency of the AC signal component and a 180° phase shift from the AC signal component. This phase shift control causes the AC signal components to cancel and reduce the AC harmonic signal component at the output of the bulk charger circuits 342. The cancellation of the output ripple and output signal harmonics provides a “cleaner” charging signal to the rechargeable energy source 326 of the electric work machine, allowing for a higher power charging signal than if DC ripple and AC harmonics were present on the output of the charging system.

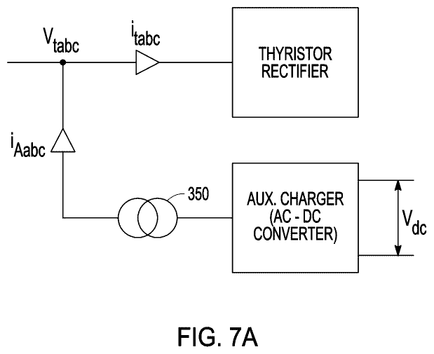

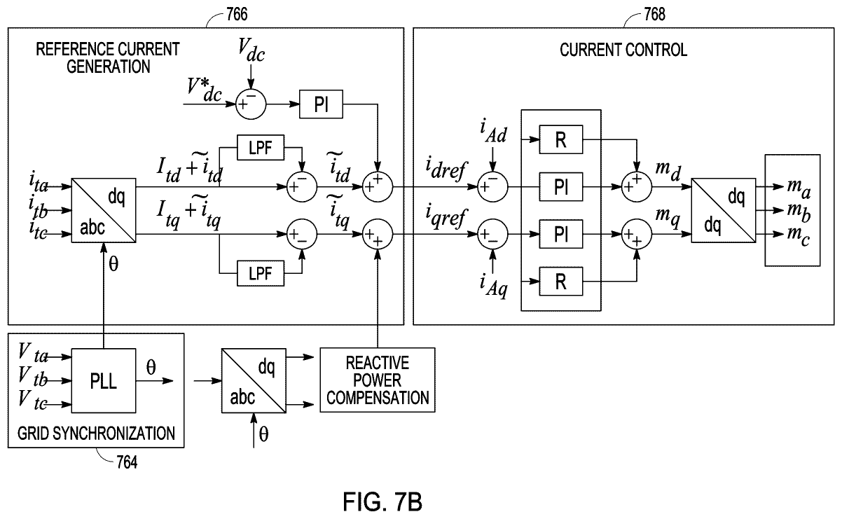

FIGS. 7A-7B show circuit diagrams of a control scheme for the hybrid high power charger 224. The AUX chargers are in effect active filters that cancel the harmonics in the output of the bulk chargers. Harmonics analysis of the bulk chargers can reveal the amplitude and the frequency of harmonics of the bulk chargers. In the control scheme, a controller 760 uses proportional-integral-resonant (PIR) control to generate control signals 762 for the switching of the rectifier circuits 352 and DC/DC converter circuits 354 of the AUX charger circuits 344.

A PI controller offers advantages in control for DC systems. However, when it comes to controlling time varying waveforms, a PI controller may be unstable and may produce steady state error. Hence, a resonant controller (R) can be implemented for harmonic compensation controller. All the 6n±1 harmonics are transformed to 6n in synchronous frame rotating at fundamental frequency (e.g., 5th and 7th harmonics will be transformed to 6th harmonic). In order to compensate harmonics till 25th the required current controller bandwidth should be at least 1500 Hz.

The PIR control produces an equal but opposite (180 degree phase shift) harmonic compensating current that is applied to the output of the bulk charger circuits 342. The resulting harmonic currents in the load current from the bulk charger circuits 342 is greatly reduced. This reduces the total harmonic distortion in the charging current or load current and improves the power factor of the charging current.

The control scheme includes grid synchronization block 764, reference current generator 766, and current control block 768. For grid synchronization, the auxiliary charger is synchronized with input voltage of thyristor rectifier circuit 352 (V_{t_a,b,c}) using a three phase PLL. The output of PLL is angle θ.

In the reference current generator 766, the reference current to the aux charger is generated based on the measured thyristor rectifier currents (i_{t,a,b,c}). The measured thyristor currents (i_{t,a,b,c}) are transformed into synchronously rotating d-q reference frame(I_{t_d,q}+i_{t_d,q}). The fundamental frequency component (60 Hz) in i_{t_a,b,c} will appear as dc component (I_{t_d,q}) in d-q reference frame. The odd harmonic components (6n+/−1) in (i_{t a,b,c}) will appear as even harmonics of order 6n (i_{t_d,q}) in d-q reference frame. The objective for aux charger is to supply the harmonics the thyristor rectifier is generating. Hence the DC component (I_{td}) is filtered out using a High Pass Filter (HPF=1−LPF). The d-axis current (i_{dref}) corresponds to real power component of current. The q-axis current (i_{qref}) corresponds to reactive power component. The DC link voltage of aux charger is controlled by controlling the real power component of current (i_{dref}). The reactive power drawn by thyristor rectifier is controlled by controlling the q-axis component of aux charger (i_{qref}).

In the current control block 768, the measured aux charger currents (i_{Ad}, i_{Aq}) are compared with the reference currents generated(i_{dref}, i_{qref}) and the error is passed. Since the reference currents are time varying quantities due to presence of 6n order harmonics, using traditional PI control will result in non-zero steady state error. Hence a resonant controller (R) is used in combination with PI to provide zero steady state error to the harmonic components The bandwidth of current control is selected based on the highest harmonic to be compensated. The output of current controller is modulating signals (m__{a,b,c}) which are passed to the PWM block to generate gate pulses.

### INDUSTRIAL APPLICABILITY

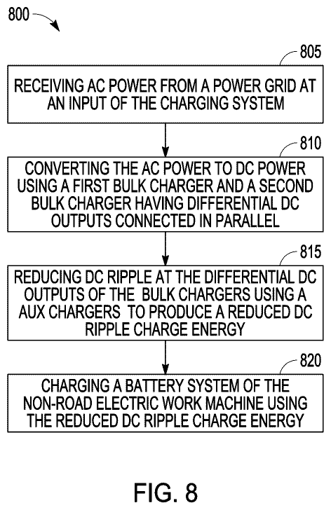

FIG. 8 is a flow diagram of an example of a method 800 of operating a charging system for a non-road electric work machine. The method may be performed using the hybrid high power charger 224 of FIG. 2 and FIG. 3. The charging system may be coupled to a power grid at a job site, such as an MV Grid 228.

At block 805, the charging system receives AC power from the power grid. The AC power is provided to an AC/DC converter to produce DC charging energy to charge a battery system of a work machine.

At block 810, the AC power is converted to DC power using a first bulk charger and a second bulk charger. The bulk chargers may include rectifier circuits to convert the AC power to DC power. The AC power received from the grid may be applied to a transformer interface that produces an AC power input for each of the bulk chargers. The AC inputs may be filtered at the bulk chargers using a passive filter circuit. The bulk chargers both have differential DC outputs, and the DC outputs of the two bulk chargers are connected together in parallel at the output of the charging system. This allows the charging system to provide a high power charging signal to the battery system. The outputs of the bulk chargers may be connected to an additional passive filter circuit.

At block 815, a first AUX charger is used to reduce the DC ripple at the differential DC output of the first bulk charger, and a second AUX charger is used to reduce the DC ripple at the differential DC output of the second bulk charger. The AUX chargers also convert AC power to DC power. The AUX chargers are connected in parallel to the bulk chargers. The input of the AUX charger may be isolated from the input of its corresponding bulk charger using another transformer interface. The outputs of the AUX chargers are connected in parallel to the output of its corresponding bulk charger. The AUX chargers are active filter circuits. The AUX chargers produce compensating current with the harmonic frequencies of the bulk chargers, but with an opposite phase to cancel the harmonics and ripple in the output current of the bulk chargers to create a reduced DC ripple charge energy.

At block 820, the reduced DC ripple charge energy is used to charge the battery system of the electric work machine. As noted previously herein, reducing the DC ripple in the charge current improves the power factor of the charge signal provided to the battery system. The reduced DC ripple and improved power factor allow for a higher current to be used to charge the battery system than would be useable without the active filtering of the AUX chargers.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A charging system for a non-road electric vehicle, the charging system comprising:
a transformer coupling to connect the charging system to a power grid, wherein the transformer coupling includes a three-winding transformer;
a first bulk charger including an input connected to the three-winding transformer and a differential output to be connected to a charging load;
a second bulk charger including an input connected to the three-winding transformer and a differential output connected in parallel to the differential output of the first bulk charger;
a first auxiliary (AUX) charger including an isolation transformer connected to the input of the first bulk charger and a differential output connected in parallel to the differential output of the first bulk charger;
a second AUX charger including an isolation transformer connected to the input of the second bulk charger and a differential output connected in parallel to the differential output of the second bulk charger; and
wherein operating the first and second AUX chargers improves a power factor of the first and second bulk chargers.

2. The charging system of claim 1,
wherein the differential output of the first bulk charger is a direct current (DC) output that includes a DC ripple output when operating; and
wherein the first AUX charger provides a ripple output signal having a one hundred eighty degree (180°) phase shift from the DC ripple output of the first bulk charger.

3. The charging system of claim 2, wherein the first and second bulk chargers are first and second silicon controlled rectifier (SCR) based bulk chargers.

4. The charging system of claim 1,
wherein the differential output of the first bulk charger is a direct current (DC) output that includes an alternating current (AC) signal component having a harmonic frequency of a fundamental frequency of the power grid when operating; and
wherein the first AUX charger provides a current output signal having the harmonic frequency of the AC signal component and a 180° phase shift from the AC signal component.

5. The charging system of claim 1, wherein the first and second AUX chargers each include:
a pulse width modulated (PWM) rectifier circuit having an input connected to its respective isolation transformer; and
a direct current to direct current (DC-to-DC) converter having an input connected to the output of the PWM rectifier circuit.

6. The charging system of claim 5, wherein each DC-to-DC converter of the first and second AUX chargers includes a dual active bridge (DAB) DC-to-DC converter.

7. The charging system of claim 5, wherein the PWM rectifier circuit includes insulated gate transistors.

8. The charging system of claim 1, wherein the first and second AUX chargers each include:
an active front end (AFE) rectifier circuit having an input connected to its respective isolation transformer; and
a direct current to direct current (DC-to-DC) converter having an input connected to the output of the AFE rectifier circuit.

9. The charging system of claim 8, wherein the AFE rectifier circuit includes insulated gate transistors.

10. The charging system of claim 1, including a passive filter circuit connected to the differential outputs of the first and second bulk chargers.

11. The charging system of claim 1, wherein the charging system is included in a megawatt charging station (MCS) and the power grid is a medium voltage work-site power grid.

12. A method of operating a charging system for a non-road electric work machine, the method comprising:
receiving alternating current (AC) power from a work-site power grid at an input of the charging system;
converting the AC power to direct current (DC) power using a first bulk charger and a second bulk charger, wherein the second bulk charger includes a differential DC output connected in parallel to a differential DC output of the first bulk charger, and wherein the differential DC outputs of the first and second bulk chargers include DC ripple when the first and second bulk chargers are operating;
reducing the DC ripple at the differential DC output of the first bulk charger using a first auxiliary (AUX) charger and reducing the DC ripple at the differential DC output of the second bulk charger using a second AUX charger to produce a reduced DC ripple charge energy; and
charging a battery system of the non-road electric work machine using the reduced DC ripple charge energy.

13. The method of claim 12,
wherein the reducing the DC ripple includes producing a ripple signal at the output of the first AUX charger having a one hundred eighty degree (180°) phase shift from the DC ripple output of the first bulk charger, and producing a ripple signal at the output of the second AUX charger having a 180° phase shift from the DC ripple output of the second bulk charger.

14. The method of claim 13, wherein the producing the ripple signal includes setting pulse width modulation (PWM) of an AC-to-DC rectifier circuit included in each of the first and second AUX chargers to produce the 180° phase shift from the DC ripple output.

15. The method of claim 12, including:
producing a first bulk charger output signal and a second bulk charger output signal, wherein each of the first and second bulk charger output signals includes an alternating current (AC) signal component having a harmonic frequency of a fundamental frequency of the work-site power grid when operating the first bulk charger; and
producing a first AUX charger current output signal and a second AUX charger current output signal, wherein each of the first and second AUX charger current output signal includes the harmonic frequency of the AC signal component and a 180° phase shift from the AC signal component.

16. The method of claim 15, including producing the first AUX charger current output signal and the second AUX charger current output signal using a proportional-resonant control circuit.

17. The method of claim 12, wherein the receiving the AC power from a medium voltage work-site grid includes receiving the AC power using a three-winding transformer of the charging system.

18. A charging system to be coupled to a medium voltage (MV) work-site power grid, the system comprising:
a transformer coupling to interface the charging system to the power grid;
a bulk charging subsystem including at least one bulk charger and a bulk differential output, wherein the bulk charging subsystem is configured to produce a direct current (DC) output signal at the bulk differential output;
an auxiliary (AUX) charging subsystem including at least one auxiliary charger and an AUX differential output connected in parallel to the bulk differential output; and
wherein operating the bulk charging subsystem produces a ripple signal component in the DC output signal and an AUX output signal produced by the AUX charging subsystem reduces the ripple signal component in the DC output signal.

19. The charging system of claim 18, wherein the AUX output signal produced by the AUX charging subsystem reduces frequency harmonics of a fundamental frequency of the MV work-site power grid in the DC output signal of the bulk charging subsystem.

20. The charging system of claim 18, wherein the transformer coupling includes transformer that includes more than two windings; the bulk charging system includes multiple silicon controlled rectifier (SCR) based bulk charger circuits connected in parallel to the transformer and the bulk differential output; and the AUX charging subsystem includes an auxiliary charger circuit coupled in parallel to each of the SCR based bulk charger circuits.
